(19) United States
(12) Patent Application Publication
(10) Pub. No.: US 2025/0379629 A1
(43) Pub. Date: Dec. 11, 2025

(54) METHOD AND APPARATUS FOR CALCULATING CHANNEL QUALITY INFORMATION AND COMMUNICATION SYSTEM

(71) Applicant: FUJITSU LIMITED, Kawasaki-shi (JP)

(72) Inventors: Yiwen LU, Beijing (CN); Jian ZHANG, Beijing (CN); Lei ZHANG, Beijing (CN); Xin WANG, Beijing (CN)

(73) Assignee: FUJITSU LIMITED, Kawasaki-shi (JP)

(21) Appl. No.: 19/301,298

(22) Filed: Aug. 15, 2025

Related U.S. Application Data
(63) Continuation of application No. PCT/CN2023/076814, filed on Feb. 17, 2023.

(51) Int. Cl. H04B 7/06; H04W 72/23

(52) U.S. Cl. CPC H04B 7/0626; H04B 7/0632; H04W 72/23

(57) ABSTRACT

A method and apparatus for calculating channel quality information and a communication system. The apparatus applicable to a terminal equipment and includes: a receiver configured to receive first channel state information reference signal (CSI-RS) resource configuration from a network device, the first CSI-RS resource configuration at least including a first resource set having K CSI-RS resources, K being a natural number greater than or equal to 2; and a processor circuitry configured to calculate a channel quality indicator (CQI) at least based on M CSI-RS resources, the M CSI-RS resources being related to K CSI-RS resources, and M being a natural number less than or equal to K, wherein the calculation of the CQI is at least based on an assumed first physical downlink shared channel (PDSCH) signal, the first PDSCH transmitted on antenna ports [1000, . . . , 1000+v−1], the first PDSCH related to corresponding symbols transmitted on antenna ports [3000, . . . , 3000+P−1].

### CROSS-REFERENCE TO RELATED APPLICATION

This application is a continuation application under 35 U.S.C. 111 (a) of International Patent Application PCT/CN2023/076814 filed on Feb. 17, 2023, and designated the U.S., the entire contents of which are incorporated herein by reference.

### TECHNICAL FIELD

This disclosure relates to the field of communication technologies.

### BACKGROUND

In a New Radio (NR) system, users may measure a current channel according to channel state information (CSI) resource settings and CSI reporting settings configured by a network device side, and carry the channel state information by uplink control information (UCI) in an uplink channel (such as a physical uplink control channel PUCCH, a physical uplink shared channel PUSCH) for reporting feedback.

The multiple transmission reception point (M-TRP) cooperative transmission scheme is an important technology in NR systems to improve the throughput of cell edge usage and provide more balanced service quality for serving cells. The M-TRP transmission scheme can be roughly divided into two types: a coherent joint transmission (C-JT) scheme and an incoherent joint transmission (NC-JT) scheme. The specific implementation difference between the two is reflected in the different mapping relationships from layers to multiple TRPs. For the C-JT scheme, all physical downlink shared channel/demodulation reference signals (PDSCH/DMRS) ports jointly transmitted from multiple transmission points (TRPs) and signals from multiple TRPs are coherently transmitted; For the NC-JT scheme, the PDSCH/DMRS ports are sent separately from each TRP.

FIG. 1 is a schematic diagram of single point transmission, coherent joint transmission and incoherent joint transmission. A in FIG. 1 corresponds to single point transmission, B in FIG. 1 corresponds to C-JT transmission, and C in FIG. 1 corresponds to NC-JT.

In Rel-15/16, users report CSI based on the single transmission reception point (S-TRP) scheme, which includes precoding matrix indication (PMI), rank indication (RI), layer indication (LI), channel quality indication (CQI), etc. Rel-17 supports enhanced CSI resource allocation and reporting for NC-JT scheme. Terminal devices can perform joint channel measurements based on reference signals sent from M transmission points based on NC-JT transmission, and report M PMIs, M RIs, M LIs, and N CQIs (single codeword N=1, double codeword N=2), etc. And currently only supports CSI reporting based on the ‘typeI single panel’ codebook configuration.

When coherent joint transmission occurs, each data layer is mapped onto multiple TRP/panels participating in cooperation through weighted vectors, which is equivalent to concatenating multiple sub-arrays into a higher dimensional virtual array. Therefore, the C-JT transmission scheme can achieve higher shaping/precoding/multiplexing gains and significantly improve the throughput of edge users and the average throughput of the cell.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

According to the data/reference signal transmission and mapping characteristics in the CJT transmission scheme, the terminal equipment needs to perform joint channel measurement based on the reference signals sent by K multiple transmission points based on C-JT transmission, and jointly feedback single CSI information such as PMI, RI, LI, CQI, etc.

However, the current CSI feedback mechanism of Rel-15˜Rel-17 standards cannot be applied to the CSI feedback of C-JT transmission schemes. That is, the CSI feedback from terminal devices cannot accurately and completely reflect the true channel quality experienced by the resource ports of C-JT, thereby reducing the accuracy and reliability of data scheduling, resulting in a decrease in data transmission performance, single user, and overall network throughput.

In order to solve at least one of the above problems or other similar problems, the embodiments of this disclosure provide a method and apparatus for calculating channel quality information and a communication system, in which by setting a mapping relationship between a physical downlink shared channel (PDSCH) and a corresponding symbol, a channel quality indicator (CQI) may be calculated to accurately obtain channel quality information, thereby improving data transmission performance, enhancing single user and overall network throughput.

According to one aspect of the embodiments of this disclosure, there is provided an apparatus for calculating channel quality information, applicable to a terminal equipment, the apparatus including:
a first receiver configured to receive first channel state information reference signal (CSI-RS) resource configuration from a network device, the first CSI-RS resource configuration at least including a first resource set having K CSI-RS resources, K being a natural number greater than or equal to 2; and
a first processor configured to calculate a channel quality indicator (CQI) at least based on M CSI-RS resources, the M CSI-RS resources being related to K CSI-RS resources, and M being a natural number less than or equal to K,
wherein the calculation of the CQI is at least based on an assumed first physical downlink shared channel (PDSCH) signal, the first PDSCH being transmitted on antenna ports [1000, . . . , 1000+v−1], the first PDSCH being related to corresponding symbols transmitted on antenna ports [3000, . . . , 3000+P−1].

According to another aspect of the embodiments of this disclosure, there is provided a method for calculating channel quality information, applicable to a terminal equipment, the method including:
receiving first channel state information reference signal (CSI-RS) resource configuration by the terminal equipment from a network device, the first CSI-RS resource configuration at least including a first resource set having K CSI-RS resources, K being a natural number greater than or equal to 2; and
calculating a channel quality indicator (CQI) at least based on M CSI-RS resources, the M CSI-RS resources being related to K CSI-RS resources, and M being a natural number less than or equal to K,
wherein the calculation of the CQI is at least based on an assumed first physical downlink shared channel (PDSCH) signal, the first PDSCH being transmitted on antenna ports [1000, . . . , 1000+v−1], the first PDSCH being related to corresponding symbols transmitted on antenna ports [3000, . . . , 3000+P−1].

An advantage of the embodiments of this disclosure exists in that by setting a mapping relationship between a physical downlink shared channel (PDSCH) and a corresponding symbol, a channel quality indicator (CQI) may be calculated to accurately obtain channel quality information, thereby improving data transmission performance, enhancing single user and overall network throughput.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the invention may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of single point transmission, coherent joint transmission and incoherent joint transmission;

FIG. 2 is a schematic diagram of a communication system of this disclosure;

FIG. 3 is a schematic diagram of the method for calculating channel quality information of the first aspect of this disclosure;

FIG. 4 is a schematic diagram of the apparatus for calculating channel quality information of the second aspect of this disclosure;

FIG. 5 is a schematic diagram of the terminal equipment of the third aspect of this disclosure; and

FIG. 6 is a schematic diagram of the network device of the third aspect of this disclosure.

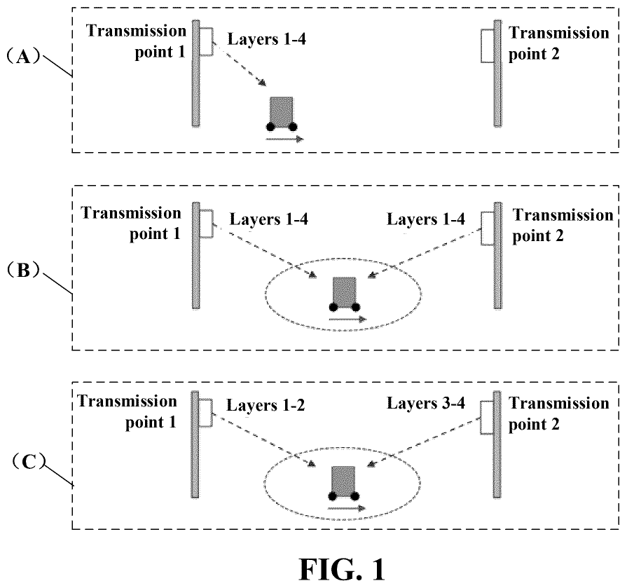

### DETAILED DESCRIPTION OF THE DISCLOSURE

These and further aspects and features of this disclosure will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, 5G and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: an integrated access and backhaul node (IAB node), a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

In the following description, without causing confusion, the terms “uplink control signal” and “uplink control information (UCI)” or “physical uplink control channel (PUCCH)” may be replaced with each other, and terms “uplink data signal” and “uplink data information” or “physical uplink shared channel (PUSCH)” may be replaced with each other.

The terms “downlink control signal” and “downlink control information (DCI)” or “physical downlink control channel (PDCCH)” may be replaced with each other, and the terms “downlink data signal” and “downlink data information” or “physical downlink shared channel (PDSCH)” may be replaced with each other.

In addition, transmitting or receiving a PUSCH may be understood as transmitting or receiving uplink data carried by the PUSCH, transmitting or receiving a PUCCH may be understood as transmitting or receiving uplink information carried by the PUCCH, transmitting or receiving a PRACH may be understood as transmitting or receiving a preamble carried by the PRACH. The uplink signal may include an uplink data signal and/or an uplink control signal, etc., and may be referred to as uplink transmission or uplink information or an uplink channel. Transmitting uplink transmission on an uplink resource may be understood as transmitting the uplink transmission by using the uplink resource. Likewise, downlink data/signal/channel/information may be understood correspondingly.

In the embodiments of this disclosure, high-layer signaling may be, for example, radio resource control (RRC) signaling; for example, it is referred to an RRC message, which includes an MIB, system information, and a dedicated RRC message; or, it is referred to an as an RRC information element (RRC IE). Higher-layer signaling may also be, for example, medium access control (MAC) signaling, or an MAC control element (MAC CE); however, this disclosure is not limited thereto.

Scenarios in the embodiments of this disclosure shall be described below by way of examples; however, this disclosure is not limited thereto.

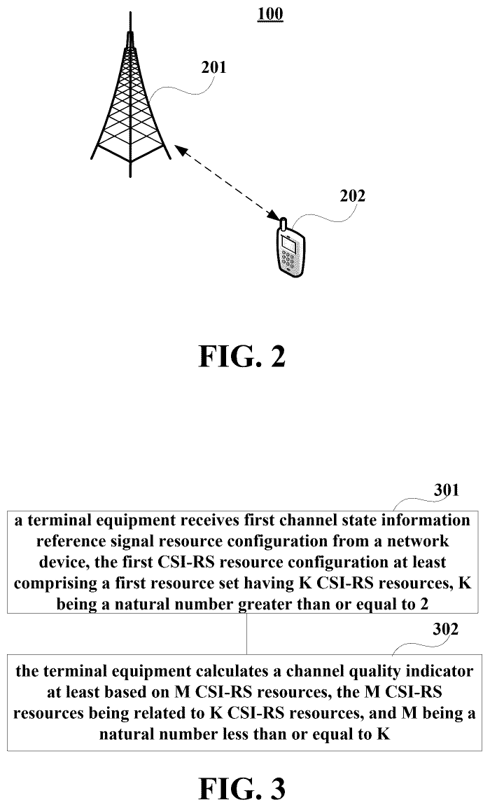

FIG. 2 is a schematic diagram of a communication system of this disclosure, in which a case where a terminal equipment and a network device are taken as examples is schematically shown. As shown in FIG. 2, the communication system 100 may include a network device 201 and a terminal equipment 202 (for the sake of simplicity, an example having only one terminal equipment is schematically given in FIG. 2).

In the embodiment of this disclosure, existing traffics or traffics that may be implemented in the future may be performed between the network device 201 and the terminal equipment 202. For example, such traffics may include but not limited to enhanced mobile broadband (eMBB), massive machine type communication (MTC), and ultra-reliable and low-latency communication (URLLC), etc.

The terminal equipment 202 may transmit data to the network device 201, such as in a grant or grant-free manner. The network device 201 may receive data transmitted by one or more terminal equipments 202, and feed back information to the terminal equipment 202, such as acknowledgement (ACK)/non-acknowledgement (NACK) information, and the terminal equipment 202 may acknowledge to terminate a transmission process, or may perform transmission of new data, or may perform data retransmission.

In the embodiments of this disclosure, reporting may refer to an action of transmitting information by the terminal equipment to the network device. For example, reporting CSI by the terminal equipment may refer to transmitting CSI by the terminal equipment to the network device.

In the current standardization process, there is clear support for C-JT transmission schemes and CSI reporting enhancement based on C-JT. Among them, the terminal equipment may perform joint channel measurement based on the reference signals sent by K transmission points based on C-JT transmission, and jointly report a single PMI, RI, LI, and N CQIs (single codeword N=1, double codeword N=2), etc.

In the C-JT transmission scheme, the terminal equipment may receive a channel state information reference signal resource setting configured by the network device, which includes K CSI-RS resources. Each resource may be associated with a joint transmission point, or the terminal equipment may consider K resources to be sent separately by K transmission points. Therefore, terminal equipments may determine the channel state information of each transmission point in C-JT joint transmission by measuring each CSI-RS resource, or by jointly calculating K resources to determine the channel state information in C-JT joint transmission. In addition, terminal equipments may also select and report M optimal CSI-RS resources based on K CSI-RS measurement results, for example, the selected resources may be reported through a log (K) bit bitmap.

The C-JT transmission scheme supports the calculation and joint feedback of the following precoding information based on K CSI-RS resources:

$$w ( i ) = [ \begin{matrix}{w}_{1} ( i ) \\ … \\ {w}_{K} ( i )\end{matrix} ] .$$

In an NR system, a terminal equipment may measure the channel state based on the received non-zero power (NZP) CSI-RS resources and provide feedback based on the reported quantity configuration in the reporting settings. When the reported quantity configuration includes a Channel Quality Indication (CQI) configuration, the terminal equipment may jointly calculate the reported CQI information based on the current channel estimation result and the CQI calculation assumption in the standard. For example, the method for calculating CQI on terminal equipments is as follows:
(1) The terminal equipment estimates the current channel H through CSI-RS;
(2) The terminal equipment calculates the optimal precoding information W through the estimated channel H;
(3) The terminal equipment calculates the current Signal to Interference and Noise Ratio (SINR) by pre coding the weighted channel results; and
(4) The terminal equipment fits the modulation order and SINR curve based on the SINR calculation results, and performs optimal CQI calculation and reporting using the CQI quantization definition in the standard.

CQI calculation is to reflect the channel quality information in the real channel transmission of the physical downlink shared channel (PDSCH). Therefore, in CQI calculation, the terminal equipment needs to map the received PDSCH signals transmitted on antenna ports [1000, . . . , 1000+v−1] to the related signals transmitted on antenna ports [3000, . . . , 3000+P−1] (as CSI-RS signals start transmitting at port 3000, where the related signals specifically refer to CSI-RS signals). For example, in the NR system, the mapping relationship shown in Table 1 is specified based on single point transmission.

TABLE 1
For CQI calculation, the UE should assume that PDSCH signals on
antenna ports in the set [1000, . . . , 1000 + v − 1] for v layers
would result in signals equivalent to corresponding symbols
transmitted on antenna ports [3000, . . . , 3000 + P − 1], as given by
$[ \begin{matrix}{y}^{( 3000 )} ( i ) \\ … \\ {y}^{( 3000 + P - 1 )} ( i )\end{matrix} ] = W ( i ) [ \begin{matrix}{x}^{( 0 )} ( i ) \\ … \\ {x}^{( v - 1 )} ( i )\end{matrix} ]$

where, x(i) denotes the signal information of v layers of the PDSCH. Since the PDSCH ports are mapped one-to-one with each layer, x(i) also denotes the signal information of v PDSCH ports [1000, . . . , 1000+v−1]. Y (i) denotes the port signal information corresponding to P CSI-RS.

Based on the content of Table 1, there is a precoding mapping relationship between the channel state information calculated through CSI-RS and the actual PDSCH transmission port. Therefore, when calculating CQI, the terminal equipment needs to calculate the precoding information in advance, weight the precoding according to the current mapping relationship, calculate and feedback the channel quality information assuming the PDSCH transmission channel, such as CQI.

### Embodiments of a First Aspect

According to the existing CQI calculation assumption, when based on single point transmission, only the mapping relationship between all ports of a CSI-RS resource and the PDSCH port is specified, and the precoding information W is a single piece of information. However, in the C-JT transmission scheme, K transmission points should correspond to K CSI-RS resources respectively, and all ports of the PDSCH should correspond to all transmission points. Therefore, the current mapping relationship (as shown in Table 1 above) is not sufficient to reflect the port correspondence relationship of the C-JT transmission scheme. In addition, in the case where the terminal device feedbacks joint precoding information from multiple transmission points, if based on the current mapping relationship, the corresponding relationship of W is not clear, which can also lead to incorrect assumptions in CQI calculation.

In summary, under the current assumption of CQI calculation, the CQI information calculated by terminal devices based on existing technology cannot accurately and completely reflect the quality of the real channel experienced by the resource ports of C-JT, thereby reducing the accuracy and reliability of data scheduling, resulting in a decrease in data transmission performance, single user and overall network throughput.

In order to solve at least one of the above problems or other similar problems, the embodiment of the first aspect of this disclosure provides a method for calculating channel quality information, applicable to a terminal equipment. In the following description, the terminal equipment may be, for example, the terminal equipment 202 in FIG. 2, and the network device in communication with the terminal equipment may be, for example, the network device 201 in FIG. 2.

FIG. 3 is a schematic diagram of the method for calculating channel quality information of the first aspect of this disclosure. As shown in FIG. 3, the method includes:
operation 301: a terminal equipment receives first channel state information reference signal (CSI-RS) resource configuration from a network device, the first CSI-RS resource configuration at least including a first resource set having K CSI-RS resources, K being a natural number greater than or equal to 2; and
operation 302: the terminal equipment calculates a channel quality indicator (CQI) at least based on M CSI-RS resources, the M CSI-RS resources being related to K CSI-RS resources, and M being a natural number less than or equal to K.

In operation 302, the calculation of the CQI is at least based on an assumed first physical downlink shared channel (PDSCH) signal, the first PDSCH being transmitted on antenna ports [1000, . . . , 1000+v−1], the first PDSCH being related to corresponding symbols transmitted on antenna ports [3000, . . . , 3000+P−1].

In some embodiments, a relationship between the first PDSCH and the corresponding symbol is expressed as equation (1) below:

$$[ \begin{matrix}{Y}_{{k}_{-} 0} ( i ) \\ … \\ {Y}_{{k}_{-} M - 1} ( i )\end{matrix} ] = W ( i ) [ \begin{matrix}{x}^{( 0 )} ( i ) \\ … \\ {x}^{( v - 1 )} ( i )\end{matrix} ] ; \qquad ( 1 )$$

where, x(i)=[x⁽⁰⁾(i) . . . x^{(v-1)}(i)]^{T} denotes signal vectors of v layers of the first PDSCH,

$${Y}_{k \_ j} ( i ) = [ \begin{matrix}{y}_{k \_ j}^{( 3000 )} ( i ) \\ … \\ {y}_{k \_ j}^{( 3000 + P - 1 )} ( i )\end{matrix} ]$$

are signals transmitted at the antenna ports [3000, . . . , 3000+P−1] and are related to a (k_j+1)-th CSI-RS signal in the first resource set, and

$$W ( i ) = [ \begin{matrix}{w}^{( k \_ 0 )} ( i ) \\ … \\ {w}^{( k \_ M - 1 )} ( i )\end{matrix} ]$$

is a precoding matrix obtained by applying a PMI reported based on the M CSI-RS resources to x(i).

In some other embodiments, a relationship between the first PDSCH and the corresponding symbols expressed as equation (2) below:

$$[ \begin{matrix}{Y}_{0} ( i ) \\ … \\ {Y}_{k - 1} ( i )\end{matrix} ] ⊗ {[ {r}_{0} ... {r}_{k - 1} ]}^{T} = W ( i ) [ \begin{matrix}{x}^{( 0 )} ( i ) \\ … \\ {x}^{( v - 1 )} ( i )\end{matrix} ] ; \qquad ( 2 )$$

where, x(i)=[x⁽⁰⁾(i) . . . x^{(v-1)}(i)]^{T} denotes signal vectors of v layers of the first PDSCH,

$${Y}_{j} ( i ) = [ \begin{matrix}{y}_{j}^{( 3000 )} ( i ) \\ … \\ {y}_{j}^{( 3000 + P - 1 )} ( i )\end{matrix} ]$$

are signals transmitted at the antenna ports [3000, . . . , 3000+P−1] and are related to a (j+1)-th CSI-RS signal in the first resource set, and

$$W ( i ) = [ \begin{matrix}{w}^{( 0 )} ( i ) \\ … \\ {w}^{( k \_ M - 1 )} ( i )\end{matrix} ]$$

is a precoding matrix obtained by applying a PMI reported based on the M CSI-RS resources to x(i).

In equation (2), the [r₀ . . . rₖ₋₁]^{T} is used to determine a correlation between the M CSI-RS resources and the K CSI-RS resources. For example, [r₀ . . . rₖ₋₁]^{T} corresponds to a bitmap with K bits. The terminal equipment determines and reports a selection results of the M CSI-RS resources according to the information on the bitmap.

In some embodiments, that the M CSI-RS resources are related to the K CSI-RS resources in operation 302 includes: the M CSI-RS resources are M CSI-RS resources in the K CSI-RS resources. For example, the M CSI-RS resources are M optimal CSI-RS resources in the K CSI-RS resources.

The M optimal CSI-RS resources in the K CSI-RS resources may include:
a first number of former resources with maximum reference signal received power (RSRP), the first number being less than or equal to M; and/or,
a second number of resources with RSRP greater than or equal to a predetermined threshold, the second number being less than or equal to M; and/or,
a former third number of resources with minimum block error rates (BLERs), the third number being less than or equal to M; and/or,
a fourth number of resources with BLERs less than or equal to a predetermined threshold, the fourth number being less than or equal to M.

In some embodiments, in the M CSI-RS resources and/or the K CSI-RS resources, each CSI-RS resource is transmitted on antenna ports [3000, . . . , 3000+P−1], where, P is the number of antenna ports of each CSI-RS resource.

In some embodiments, the terminal equipment performs transmission completely overlapped in a time domain and a frequency domain at the antenna ports [3000, . . . , 3000+P−1] based on the M CSI-RS resources and/or the K CSI-RS resources; where, P is the number of antenna ports of each CSI-RS resource.

The method for calculating channel quality information of this disclosure shall be described below with reference to examples.

### Example 1

In Example 1, the method for calculating channel quality information includes the following operations.

Operation 1: the network device configures a multi-point joint coherent transmission (C-JT) scheme and CSI reporting settings for the terminal equipment through high-layer signaling. In addition, the network device may also configure CSI resource settings via newly-added high-layer signaling. Thus, the terminal equipment is able to receive and measure CSI-RS resources based on CJT transmission.

The CSI resource settings include a non-zero power channel state information reference signal (NZP-CSI-RS) resource set for channel measurement. The NZP-CSI-RS resource set (i.e., a first resource set) contains K CSI-RS resources, each of which including P ports. For example, K=4, P=16.

Operation 2: the terminal equipment measures such channel information as large-scale RSRP, etc. to select a first, second and fourth CSI-RS resources in the K resources as the optimal M (M=3) CSI-RS resources, thereby determining the selection result of the M CSI-RS resources. Wherein, the reporting result of CSI-RS resource selection in the C-JT transmission scheme is 1101, that is, a bit of the reporting result 1101 is K (K=4), and the first, second and fourth bits of the reporting result are set to be 1, indicating that in the K (K=4) CSI-RS resources, the first, second and fourth resources are selected (i.e., M=3). The terminal calculates the optimal RI=2 for joint transmission by selecting the first, second and fourth CSI-RS resources.

Operation 3: optimal precoding W for joint transmission is calculated via the selected first, second and fourth CSI-RS resources. As a dimension of the precoding matrix calculated by the selected resources reported in the PMI is M (M=3), W is represented as:

$$W ( i ) = [ \begin{matrix}{w}^{( 0 )} ( i ) \\ {w}^{( 1 )} ( i ) \\ {w}^{( 2 )} ( i )\end{matrix} ] ,$$

where, w⁽¹⁾(i) corresponds to the precoding information calculated based on the first CSI-RS resource in the K (K=4) CSI-RS resources, w⁽²⁾(i) corresponds to the precoding information calculated based on the second CSI-RS resource in the K CSI-RS resources, and w⁽³⁾(i) corresponds to the precoding information calculated based on the fourth CSI-RS resource in the K CSI-RS resources.

In operation 3, the terminal equipment respectively weights the precoding information for the PDSCH port according to the following mapping relationship (i.e. performing weighting operations on the precoding information):

$$[ \begin{matrix}{Y}_{0} ( i ) \\ {Y}_{1} ( i ) \\ {Y}_{3} ( i )\end{matrix} ] = W ( i ) [ \begin{matrix}{x}^{( 0 )} ( i ) \\ {x}^{( 1 )} ( i )\end{matrix} ] ,$$

$$where , x ( i ) = [ \begin{matrix}{x}^{( 0 )} ( i ) \\ {x}^{( 1 )} ( i )\end{matrix} ]$$

denotes signal vectors of two layers (i.e. v=2) of the PDSCH, corresponding to the reported RI=2,

$${Y}_{k \_ j} ( i ) = [ \begin{matrix}{y}_{k \_ j}^{( 3000 )} ( i ) \\ … \\ {y}_{k \_ j}^{( 3000 + 16 - 1 )} ( i )\end{matrix} ]$$

are signals transmitted on antenna ports [3000, . . . , 3000+16−1] and related to a (k_j+1)-th CSI-RS signal in the CSI-RS resource set (i.e. the first resource set) in operation 2, wherein k_j is a non-negative integer greater than or equal to 0 and less than or equal to K−1, Y_{k_j}(i) corresponds to a (k_j+1)-th CSI-RS resource in 1101 of the report result bitmap. Hence, the above equation takes the following form:

$$[ \begin{matrix}[ \begin{matrix}{y}_{0}^{( 3000 )} ( i ) \\ … \\ {y}_{0}^{( 3000 + 16 - 1 )} ( i )\end{matrix} ] \\ [ \begin{matrix}{y}_{1}^{( 3000 )} ( i ) \\ … \\ {y}_{1}^{( 3000 + P - 1 )} ( i )\end{matrix} ] \\ [ \begin{matrix}{y}_{3}^{( 3000 )} ( i ) \\ … \\ {y}_{3}^{( 3000 + 16 - 1 )} ( i )\end{matrix} ]\end{matrix} ] = [ \begin{matrix}{w}^{( 0 )} ( i ) \\ {w}^{( 1 )} ( i ) \\ {w}^{( 2 )} ( i )\end{matrix} ] [ \begin{matrix}{x}^{( 0 )} ( i ) \\ {x}^{( 1 )} ( i )\end{matrix} ] .$$

In operation 3, the terminal equipment calculates a current SINR (signal to interference plus noise ratio) based on a result of the precoding weighted channel. Thus, the terminal equipment fits a modulation order and an SINR curve according to a calculation result of the current SINR, and performs optimal CQI calculation and reporting according to a CQI quantization definition in standards.

### Example 2

In Example 2, the method for calculating channel quality information includes the following operations.

Operation 1: the network device configures a multi-point joint coherent transmission (C-JT) scheme and CSI reporting settings for the terminal equipment through high-layer signaling. In addition, the network device may also configure CSI resource settings via newly-added high-layer signaling. Thus, the terminal equipment is able to receive and measure CSI-RS resources based on CJT transmission.

The CSI resource settings include a non-zero power channel state information reference signal (NZP-CSI-RS) resource set for channel measurement. The NZP-CSI-RS resource set (i.e. a first resource set) contains K CSI-RS resources, each of which including P ports. For example, K=4, P=16.

Operation 2: the terminal equipment measures such channel information as large-scale RSRP, etc. to select a first, second and fourth CSI-RS resources in the K CSI-RS resources as the optimal M (M=3) CSI-RS resources, thereby determining the selection result of the M CSI-RS resources. Wherein, the reporting result of CSI-RS resource selection in the C-JT transmission scheme is 1101, that is, a bit of the reporting result 1101 is K (K=4), and the first, second and fourth bits of the reporting result are set to be 1, indicating that in the K (K=4) CSI-RS resources, the first, second and fourth resources are selected (i.e., M=3). The terminal calculates the optimal RI=2 for joint transmission by selecting the first, second and fourth CSI-RS resources.

Operation 3: optimal precoding W for joint transmission is calculated via the selected first, second and fourth CSI-RS resources. As a dimension of the precoding matrix calculated by the selected resources reported in the PMI is M, W is represented as:

$$W ( i ) = [ \begin{matrix}{w}^{( 1 )} ( i ) \\ {w}^{( 2 )} ( i ) \\ {w}^{( 3 )} ( i )\end{matrix} ] ,$$

where, w⁽¹⁾(i) corresponds to the precoding information calculated based on the first CSI-RS resource in the K (K=4) CSI-RS resources, w⁽²⁾(i) corresponds to the precoding information calculated based on the second CSI-RS resource in the K (K=4) CSI-RS resources, and w⁽³⁾(i) corresponds to the precoding information calculated based on the fourth CSI-RS resource in the K (K=4) CSI-RS resources.

In operation 3, the terminal equipment respectively weights the precoding information for the PDSCH port according to the following mapping relationship:

$$[ \begin{matrix}{Y}_{0} ( i ) \\ {Y}_{1} ( i ) \\ {Y}_{2} ( i ) \\ {Y}_{3} ( i )\end{matrix} ] ⊗ {[ {r}_{0} ... {r}_{k - 1} ]}^{T} = W ( i ) [ \begin{matrix}{x}^{( 0 )} ( i ) \\ {x}^{( 1 )} ( i )\end{matrix} ] ,$$

$$where , x ( i ) = [ \begin{matrix}{x}^{( 0 )} ( i ) \\ {x}^{( 1 )} ( i )\end{matrix} ]$$

denotes signal vectors of two layers of the PDSCH, corresponding to the reported RI=2, [r₀ . . . rₖ₋₁]^{T} is used to determine a correlation between the M CSI-RS resources and the K CSI-RS resources. In some implementations, [r₀ . . . rₖ₋₁]^{T} is a bitmap having K bits, for example, [r₀ . . . rₖ₋₁]^{T} is the CSI-RS resource selection reporting result 1101 in operation 2, i.e. [r₀ . . . rₖ₋₁]^{T} is [1101]^{T}.

$${Y}_{j} ( i ) = [ \begin{matrix}{y}_{j}^{( 3000 )} ( i ) \\ … \\ {y}_{j}^{( 3000 + P - 1 )} ( i )\end{matrix} ]$$

are signals transmitted on antenna ports [3000, . . . , 3000+16-1] and related to a (j+1)-th CSI-RS signal in the CSI-RS resource set (i.e., the first resource set) in operation 2, wherein j+1 is a non-negative integer greater than or equal to 0 and less than or equal to K−1. Hence, the above equation takes the following form:

$$[ \begin{matrix}[ \begin{matrix}{y}_{0}^{( 3000 )} ( i ) \\ … \\ {y}_{0}^{( 3000 + 16 - 1 )} ( i )\end{matrix} ] \\ [ \begin{matrix}{y}_{1}^{( 3000 )} ( i ) \\ … \\ {y}_{1}^{( 3000 + P - 1 )} ( i )\end{matrix} ] \\ [ \begin{matrix}{y}_{2}^{( 3000 )} ( i ) \\ … \\ {y}_{2}^{( 3000 + 16 - 1 )} ( i )\end{matrix} ] \\ [ \begin{matrix}{y}_{3}^{( 3000 )} ( i ) \\ … \\ {y}_{3}^{( 3000 + 16 - 1 )} ( i )\end{matrix} ]\end{matrix} ] ⊗ {[ 1101 ]}^{T} = [ \begin{matrix}{w}^{( 0 )} ( i ) \\ {w}^{( 1 )} ( i ) \\ {w}^{( 2 )} ( i )\end{matrix} ] [ \begin{matrix}{x}^{( 0 )} ( i ) \\ {x}^{( 1 )} ( i )\end{matrix} ] .$$

In operation 3, the terminal equipment calculates a current SINR (signal to interference plus noise ratio) based on a result of the precoding weighted channel. Thus, the terminal equipment fits a modulation order and an SINR curve according to a calculation result of the current SINR, and performs optimal CQI calculation and reporting according to a CQI quantization definition in standards.

The embodiment of the first aspect of this disclosure provide a method for calculating channel quality information, in which by setting a mapping relationship between a physical downlink shared channel (PDSCH) and a corresponding symbol, a channel quality indicator (CQI) may be calculated to accurately obtain channel quality information, thereby improving data transmission performance, enhancing single user and overall network throughput.

### Embodiments of a Second Aspect

At least addressed to the same problem as the embodiments of the first aspect, the embodiments of the second aspect of this disclosure provide an apparatus for calculating channel quality information, applicable to a terminal equipment, and corresponding to the embodiment of the first aspect.

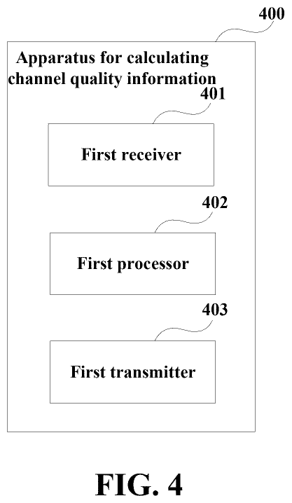

FIG. 4 is a schematic diagram of the apparatus for calculating channel quality information of the second aspect of this disclosure. As shown in FIG. 4, an apparatus 400 for calculating channel quality information includes a first receiver 401, a first processor 402 and a first transmitter 403.

In some embodiments, the first receiver 401 receives first channel state information reference signal (CSI-RS) resource configuration from a network device, the first CSI-RS resource configuration at least including a first resource set having K CSI-RS resources, K being a natural number greater than or equal to 2;
and the first processor 402 calculates a channel quality indicator (CQI) at least based on M CSI-RS resources, the M CSI-RS resources being related to K CSI-RS resources, and M being a natural number less than or equal to K,
wherein the calculation of the CQI is at least based on an assumed first physical downlink shared channel (PDSCH) signal, the first PDSCH being transmitted on antenna ports [1000, . . . , 1000+v−1], the first PDSCH being related to corresponding symbols transmitted on antenna ports [3000, . . . , 3000+P−1].

In some embodiments, a relationship between the first PDSCH and the corresponding symbol is

$$[ \begin{matrix}{Y}_{k \_ 0} ( i ) \\ … \\ {Y}_{k \_ M - 1} ( i )\end{matrix} ] = W ( i ) [ \begin{matrix}{x}^{( 0 )} ( i ) \\ … \\ {x}^{( v - 1 )} ( i )\end{matrix} ] ;$$

where, x(i)=[x⁽⁰⁾(i) . . . x^{(v-1)}(i)]^{T} denotes signal vectors of v layers of the first PDSCH,

$${Y}_{k \_ j} ( i ) = [ \begin{matrix}{y}_{k \_ j}^{( 3000 )} ( i ) \\ … \\ {y}_{k \_ j}^{( 3000 + P - 1 )} ( i )\end{matrix} ]$$

are signals transmitted at the antenna ports [3000, . . . , 3000+P−1] and are related to a (k_j+1)-th CSI-RS signal in the first resource set, and

$$W ( i ) = [ \begin{matrix}{w}^{( k \_ 0 )} ( i ) \\ … \\ {w}^{( k \_ M - 1 )} ( i )\end{matrix} ]$$

is a precoding matrix obtained by applying a PMI reported based on the M CSI-RS resources to x(i).

In some other embodiments, a relationship between the first PDSCH and the corresponding symbols is

$$[ \begin{matrix}{Y}_{0} ( i ) \\ … \\ {Y}_{k - 1} ( i )\end{matrix} ] ⊗ {[ {r}_{0} ... {r}_{k - 1} ]}^{T} = W ( i ) [ \begin{matrix}{x}^{( 0 )} ( i ) \\ … \\ {x}^{( v - 1 )} ( i )\end{matrix} ] ,$$

where, x(i)=[x⁽⁰⁾(i) . . . x^{(v-1)}(i)]^{T} denotes signal vectors of v layers of the first PDSCH,

$${Y}_{j} ( i ) = [ \begin{matrix}{y}_{j}^{( 3000 )} ( i ) \\ … \\ {y}_{j}^{( 3000 + P - 1 )} ( i )\end{matrix} ]$$

are signals transmitted at the antenna ports [3000, . . . , 3000+P−1] and are related to a (j+1)-th CSI-RS signal in the first resource set, and

$$W ( i ) = [ \begin{matrix}{w}^{( 0 )} ( i ) \\ … \\ {w}^{( k \_ M - 1 )} ( i )\end{matrix} ]$$

is a precoding matrix obtained by applying a PMI reported based on the M CSI-RS resources to x(i).

In some embodiments, [r₀ . . . rₖ₋₁]^{T} is used to determine a correlation between the M CSI-RS resources and the K CSI-RS resources.

In some embodiments, the first processor 402 determines a selection result of the M CSI-RS resources according to a bitmap with K bits, and a first transmitter reports the selection result.

In some embodiments, that the M CSI-RS resources are related to the K CSI-RS resources includes:
the M CSI-RS resources are M CSI-RS resources in the K CSI-RS resources.

In some embodiments, the M CSI-RS resources are following resources in the K CSI-RS resources:
a first number of resources with maximum reference signal received power (RSRP), the first number being less than or equal to M; and/or,
a second number of resources with RSRP greater than or equal to a predetermined threshold, the second number being less than or equal to M; and/or,
a former third number of resources with minimum block error rates (BLERs), the third number being less than or equal to M; and/or,
a fourth number of resources with BLERs less than or equal to a predetermined threshold, the fourth number being less than or equal to M.

In some embodiments, in the M CSI-RS resources and/or the K CSI-RS resources,
each CSI-RS resource is transmitted on antenna ports [3000, . . . , 3000+P−1], where, P is the number of antenna ports of each CSI-RS resource.

In some embodiments, the terminal equipment performs transmission completely overlapped in a time domain and a frequency domain at the antenna ports [3000, . . . , 3000+P−1] based on the M CSI-RS resources and/or the K CSI-RS resources,
where, P is the number of antenna ports of each CSI-RS resource.

### Embodiments of a Third Aspect

The embodiments of the third aspect of this disclosure provide a communication system, including a network device and a terminal equipment.

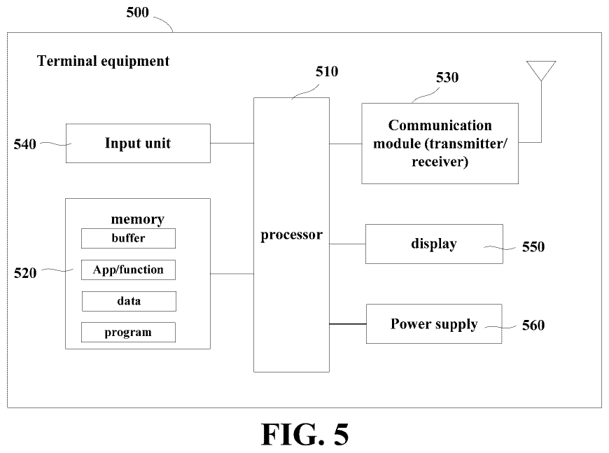

FIG. 5 is a schematic diagram of the terminal equipment of the third aspect of this disclosure. As shown in FIG. 5, a terminal equipment 500 (such as corresponding to the terminal equipment 202 in FIG. 2) may include a processor 510 and a memory 520, the memory 520 storing data and a program and being coupled to the processor 510. It should be noted that this figure is illustrative only, and other types of structures may also be used, so as to supplement or replace this structure and achieve a telecommunications function or other functions.

For example, the processor 510 may be configured to execute a program to carry out the method described in the embodiment of the first aspect.

As shown in FIG. 5, the terminal equipment 500 may further include a communication module 530, an input unit 540, a display 550, and a power supply 560, wherein functions of the above components are similar to those in the prior art, which shall not be described herein any further. It should be noted that the terminal equipment 500 does not necessarily include all the parts shown in FIG. 5, and the above components are not necessary. Furthermore, the terminal equipment 500 may include parts not shown in FIG. 5, and the prior art may be referred to.

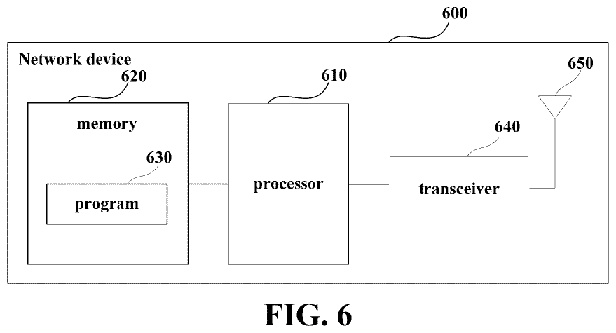

FIG. 6 is a schematic diagram of the network device of the embodiment of the third aspect. As shown in FIG. 6, a network device 600 (such as corresponding to the network device 201 in FIG. 2) may include a processor 610 (such as a central processing unit (CPU) and a memory 620, the memory 620 being coupled to the central processing unit 610. The memory 620 may store various data, and furthermore, it may store a program 630 for information processing, and execute the program under control of the central processing unit 610.

For example, the central processing unit 610 may be configured to execute a program to carry out the method described in the embodiment of the first aspect.

Furthermore, as shown in FIG. 6, the network device 600 may include a transceiver 640, and an antenna 650, etc. Wherein, functions of the above components are similar to those in the prior art, and shall not be described herein any further. It should be noted that the network device 600 does not necessarily include all the parts shown in FIG. 6, and furthermore, the network device 600 may include parts not shown in FIG. 6, and the prior art may be referred to.

An embodiment of this disclosure provides a computer readable program, which, when executed in a terminal equipment, causes the terminal equipment to carry out the method as described in the embodiment of the first aspect.

An embodiment of this disclosure provides a computer storage medium, including a computer readable program, which causes a terminal equipment to carry out the method as described in the embodiment of the first aspect.

An embodiment of this disclosure provides a computer readable program, which, when executed in a network device, causes the network device to carry out the method as described in the embodiment of the second aspect.

An embodiment of this disclosure provides a computer storage medium, including a computer readable program, which causes a network device to carry out the method as described in the embodiment of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

As to implementations containing the above embodiments, following supplements are further disclosed.

A method at a terminal equipment side:
1. A method for calculating channel quality information, applicable to a terminal equipment, the method including:
receiving, by the terminal equipment, first channel state information reference signal (CSI-RS) resource configuration from a network device, the first CSI-RS resource configuration at least including a first resource set having K CSI-RS resources, K being a natural number greater than or equal to 2; and
calculating a channel quality indicator (CQI) by the terminal equipment at least based on M CSI-RS resources, the M CSI-RS resources being related with K CSI-RS resources, and M being a natural number less than or equal to K,
wherein the calculation of the CQI is at least based on an assumed first physical downlink shared channel (PDSCH) signal, the first PDSCH being transmitted on antenna ports [1000, . . . , 1000+v−1], the first PDSCH being related to corresponding symbols transmitted on antenna ports [3000, . . . , 3000+P−1].
2. The method according to supplement 1, wherein a relationship between the first PDSCH and the corresponding symbol is

$$[ \begin{matrix}{Y}_{k \_ 0} ( i ) \\ … \\ {Y}_{k \_ M - 1} ( i )\end{matrix} ] = W ( i ) [ \begin{matrix}{x}^{( 0 )} ( i ) \\ … \\ {x}^{( v - 1 )} ( i )\end{matrix} ] ,$$

where, x(i)=[x⁽⁰⁾(i) . . . x^{(v-1)}(i)] denotes signal vectors of v layers of the first PDSCH,

$${Y}_{k \_ j} ( i ) = [ \begin{matrix}{y}_{k \_ j}^{( 3000 )} ( i ) \\ … \\ {y}_{k \_ j}^{( 3000 + P - 1 )} ( i )\end{matrix} ]$$

are signals transmitted at the antenna ports [3000, . . . , 3000+P−1] and are related to a (k_j+1)-th CSI-RS signal in the first resource set, and

$$W ( i ) = [ \begin{matrix}{w}^{( k \_ 0 )} ( i ) \\ … \\ {w}^{( k \_ M - 1 )} ( i )\end{matrix} ]$$

is a precoding matrix obtained by applying a PMI reported based on the M CSI-RS resources to x(i).
3. The method according to supplement 1, wherein a relationship between the first PDSCH and the corresponding symbols is

$$[ \begin{matrix}{Y}_{0} ( i ) \\ … \\ {Y}_{k - 1} ( i )\end{matrix} ] ⊗ {[ {r}_{0} ... {r}_{k - 1} ]}^{T} = W ( i ) [ \begin{matrix}{x}^{( 0 )} ( i ) \\ … \\ {x}^{( v - 1 )} ( i )\end{matrix} ] ,$$

where, x(i)=[x⁽⁰⁾(i) . . . x^{(v-1)}(i)]^{T} denotes signal vectors of v layers of the first PDSCH,

$${Y}_{j} ( i ) = [ \begin{matrix}{y}_{j}^{( 3000 )} ( i ) \\ … \\ {y}_{j}^{( 3000 + P - 1 )} ( i )\end{matrix} ]$$

are signals transmitted at the antenna ports [3000, . . . , 3000+P−1] and are related to a (j+1)-th CSI-RS signal in the first resource set, and

$$W ( i ) = [ \begin{matrix}{w}^{( 0 )} ( i ) \\ … \\ {w}^{( k \_ M - 1 )} ( i )\end{matrix} ]$$

is a precoding matrix obtained by applying a PMI reported based on the M CSI-RS resources to x(i).
4. The method according to supplement 3, wherein,
[r₀ . . . rₖ₋₁]^{T} is used to determine a correlation between the M CSI-RS resources and the K CSI-RS resources.
5. The method according to supplement 4, wherein,
the terminal equipment determines a selection result of the M CSI-RS resources according to a bitmap with K bits, and reports the selection result.
6. The method according to any one of supplements 1-5, wherein,
the M CSI-RS resources being related to the K CSI-RS resources includes:
the M CSI-RS resources are M CSI-RS resources in the K CSI-RS resources.
7. The method according to supplement 6, wherein,
the M CSI-RS resources are following resources in the K CSI-RS resources:
a first number of resources with maximum reference signal received power (RSRP), the first number being less than or equal to M; and/or,
a second number of resources with RSRP greater than or equal to a predetermined threshold, the second number being less than or equal to M; and/or,
a former third number of resources with minimum block error rates (BLERs), the third number being less than or equal to M; and/or,
a fourth number of resources with BLERs less than or equal to a predetermined threshold, the fourth number being less than or equal to M.
8. The method according to any one of supplements 1-7, wherein,
in the M CSI-RS resources and/or the K CSI-RS resources,
each CSI-RS resource is transmitted on antenna ports [3000, . . . , 3000+P−1], where, P is the number of antenna ports of each CSI-RS resource.
9. The method according to any one of supplements 1-7, wherein,
the terminal equipment performs transmission completely overlapped in a time domain and a frequency domain at the antenna ports [3000, . . . , 3000+P−1] based on the M CSI-RS resources and/or the K CSI-RS resources;
where, P is the number of antenna ports of each CSI-RS resource.

What is claimed is:

1. An apparatus for determining channel quality information, applicable to a terminal equipment, the apparatus comprising:
a receiver configured to receive first channel state information reference signal (CSIRS) resource configuration from a network device, the first CSIRS resource configuration at least comprising a first resource set having K CSIRS resources, K being a natural number greater than or equal to 2; and
a processor circuitry configured to determine a channel quality indicator (CQI) at least based on M CSIRS resources, the M CSIRS resources being related with K CSIRS resources, and M being a natural number less than or equal to K,
wherein the determination of the CQI is at least based on an first physical downlink shared channel (PDSCH), the first PDSCH being transmitted at antenna ports [1000, . . . , 1000+v−1], the first PDSCH being related to corresponding symbols transmitted on antenna ports [3000, . . . , 3000+P−1], wherein a relationship between the first PDSCH and the corresponding symbols is
$$[ \begin{matrix}{Y}_{0} ( i ) \\ … \\ {Y}_{M - 1} ( i )\end{matrix} ] = W ( i ) [ \begin{matrix}{x}^{( 0 )} ( i ) \\ … \\ {x}^{( v - 1 )} ( i )\end{matrix} ] ;$$
where, x(i)=[x⁽⁰⁾(i) . . . x^{(v-1)}(i)]^{T} denotes signal vectors of v layers of the first PDSCH,
$${Y}_{k \_ j} ( i ) = [ \begin{matrix}{y}_{j}^{( 3000 )} ( i ) \\ … \\ {y}_{j}^{( 3000 + P - 1 )} ( i )\end{matrix} ]$$
are signals transmitted at the antenna ports [3000, . . . , 3000+P−1], where 0<=j<=M−1 and are related to a (j+1)-th CSIRS signal within the M selected resources, and
$$W ( i ) = [ \begin{matrix}{w}^{( 0 )} ( i ) \\ … \\ {w}^{( M - 1 )} ( i )\end{matrix} ]$$
is a precoding matrix obtained by applying a PMI reported based on the M CSI-RS resources to x(i).

2. The apparatus according to claim 1, wherein,
the processor circuitry determines a selection result of the M CSIRS resources according to a bitmap with K bits, and the selection result is reported by a first transmitter.

3. The apparatus according to claim 1, wherein,
the terminal equipment performs transmission completely overlapped in a time domain and a frequency domain at the antenna ports [3000, . . . , 3000+P−1] based on the M CSIRS resources and/or the K CSIRS resources;
where, P is the number of antenna ports of each CSIRS resource.

4. A communication system, comprising a network device and a terminal equipment, wherein the terminal equipment comprising the apparatus for determining channel quality information as claimed in claim 1.

5. A method for determining channel quality information, applicable to a terminal equipment, the method comprising:
receiving, by the terminal equipment, first channel state information reference signal (CSIRS) resource configuration from a network device, the first CSIRS resource configuration at least comprising a first resource set having K CSIRS resources, K being a natural number greater than or equal to 2; and
determining a channel quality indicator (CQI) by the terminal equipment at least based on M CSIRS resources, the M CSIRS resources being related with K CSIRS resources, and M being a natural number less than or equal to K,
wherein the determination of the CQI is at least based on an first physical downlink shared channel (PDSCH), the first PDSCH being transmitted at antenna ports [1000, . . . , 1000+v−1], the first PDSCH being related to corresponding symbols transmitted on antenna ports [3000, . . . , 3000+P−1].

6. The method according to claim 5, wherein a relationship between the first PDSCH and the corresponding symbol is
$$[ \begin{matrix}{Y}_{0} ( i ) \\ … \\ {Y}_{M - 1} ( i )\end{matrix} ] = W ( i ) [ \begin{matrix}{x}^{( 0 )} ( i ) \\ … \\ {x}^{( v - 1 )} ( i )\end{matrix} ] ;$$
where, x(i)=[x⁽⁰⁾(i) . . . x^{(v-1)}(i)]^{T} denotes signal vectors of v layers of the first PDSCH,
$${Y}_{k \_ j} ( i ) = [ \begin{matrix}{y}_{j}^{( 3000 )} ( i ) \\ … \\ {y}_{j}^{( 3000 + P - 1 )} ( i )\end{matrix} ]$$
are signals transmitted at the antenna ports [3000, . . . , 3000+P−1], where 0<=j<=M−1 which are related to a (j+1)-th CSIRS signal within the M selected resources, and
$$W ( i ) = [ \begin{matrix}{w}^{( 0 )} ( i ) \\ … \\ {w}^{( M - 1 )} ( i )\end{matrix} ]$$
is a precoding matrix obtained by applying a PMI reported based on the M CSIRS resources to x(i).

7. The method according to claim 5, wherein,
the terminal equipment determines a selection result of the M CSIRS resources according to a bitmap with K bits, and reports the selection result.

8. The method according to claim 5, wherein,
the terminal equipment performs transmission completely overlapped in a time domain and a frequency domain at the antenna ports [3000, . . . , 3000+P−1] based on the M CSIRS resources and/or the K CSIRS resources;
where, P is the number of antenna ports of each CSIRS resource.

9. The method according to claim 6, wherein,
the terminal equipment performs transmission completely overlapped in a time domain and a frequency domain at the antenna ports [3000, . . . , 3000+P−1] based on the M CSIRS resources and/or the K CSIRS resources;
where, P is the number of antenna ports of each CSIRS resource.

10. The method according to claim 6, wherein,
the terminal equipment performs transmission completely overlapped in a time domain and a frequency domain at the antenna ports [3000, . . . , 3000+P−1] based on the M CSIRS resources and/or the K CSIRS resources;
where, P is the number of antenna ports of each CSIRS resource.
